(19) United States
(12) Patent Application Publication
(10) Pub. No.: US 2011/0289424 A1
(43) Pub. Date: Nov. 24, 2011

(54) SECURE APPLICATION OF CUSTOM RESOURCES IN MULTI-TIER SYSTEMS

(75) Inventors: Dag B. Rovik, Hillerod (DK); Stuart Glasson, Copenhagen (DK); Christian Abeln, Helsingborg (SE)

(73) Assignee: MICROSOFT CORPORATION, Redmond, WA (US)

(21) Appl. No.: 12/784,847

(22) Filed: May 21, 2010

(51) Int. Cl. G06F 17/30; G06F 3/01; G06F 15/16; H04L 9/32

(52) U.S. Cl. 715/744; 707/622; 713/168; 709/203; 707/E17.005

(57) ABSTRACT

Localization architecture is provided with a scalable server and a client side repository for shared user interface localization, which may be implemented in a client/display target environment. User interface localization repository is maintained server-side as a source for full or partial distribution. Content for user interface localization repository may be received from authorized partners for one or multiple client installations, and is protected against tampering.

### BACKGROUND

With the proliferation of enhanced communication networks and computing devices across multiple geographical locations, localization is becoming a crucial component of client/server communications. Localized services are placed on servers within an enterprise or online (hosted offering) and accessed by clients for a wide variety of operations. Demand for localization has increased with the continued use of applications running on variety of devices providing services to users.

Modern localization services provide localized resources in a limited number of languages. Localization services find it difficult or are incapable of meeting user demand of services for languages not covered by their implementation. A single vendor may usually be unable to provide certain requested localization resources due to lack of facilities to develop and implement such resources.

It is also difficult to provide third party solutions to localization platforms. Introduction of binary localization resources to existing platforms to implement necessary localizations create security issues. Some platforms' security implementations simply disallow any integration of binary resources necessary to implement localization services to meet user demand in client devices.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a localization architecture including a scalable server and a client side repository for shared user interface localization, which may be implemented in a client/display target environment. User interface localization repository may be maintained server-side as a source for full or partial distribution. Content for user interface localization repository may be provided by authorized partners for one or multiple client installations, and may be protected against tampering.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example localization system, where some of the content may be received from trusted sources in a client-server environment;

FIG. 2 is an action diagram displaying management of localization resources;

FIG. 3 is a conceptual diagram illustrating hosted and on-premise localization resource services;

FIG. 4 illustrates another example localization system with an example process of maintaining up-to-date localization repository client-side;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of managing localization resources in a server-client environment according to embodiments.

### DETAILED DESCRIPTION

As briefly described above, localization resources may be managed by a repository server. The repository server may receive at least a portion of the localization resources from a trusted third party. The repository server may process the localization resources and may make them available to client applications for consumption through a client-side repository linked to the master user interface repository at the server. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing computer and network operations, which may include thin or thick clients. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

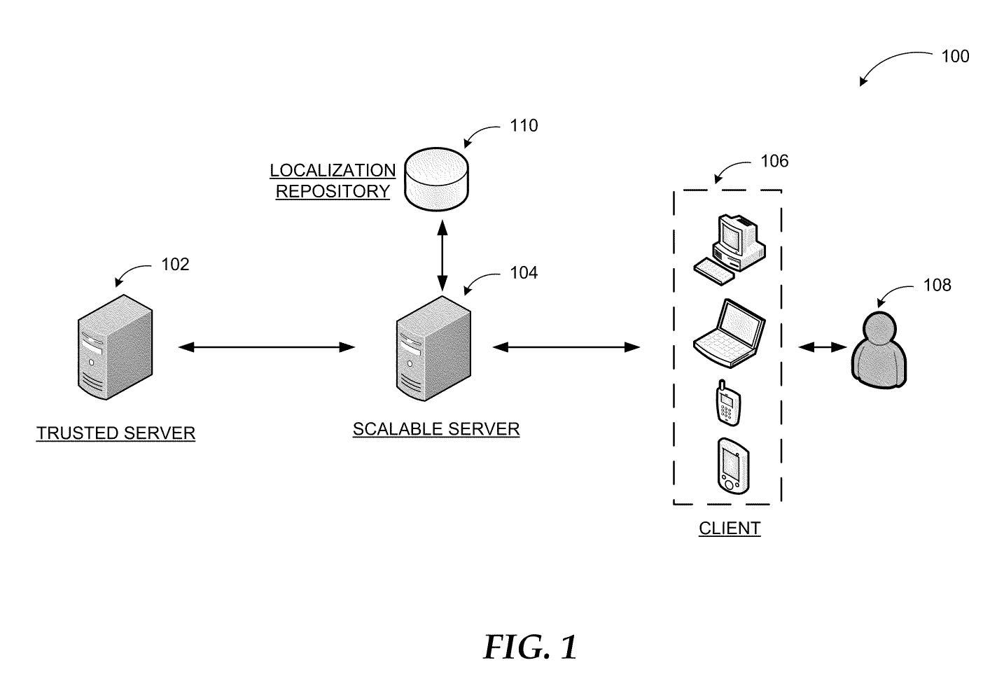

FIG. 1 is a diagram illustrating an example localization system, where some of the content may be received from trusted sources in a client-server environment. Hosted services provided in server-client environments include applications executed at one or more servers (e.g. scalable server 104), which may be accessed by a variety of client applications and devices 106. For example, user 108 may access a shared documentation service or a business service (e.g. providing data collection, analysis, reporting services) through a web browser application on one or more of his/her client devices (106). The service may be provided to a large number of users in a variety of countries and regions. Thus, localization of the user interface for language, numbering systems, and other regional/cultural aspects may be desired. Localization at the client level can be complex and unreliable since the local application (e.g. browser) cannot predict all data that will have to be rendered.

Furthermore, many hosted services include add-on modules, which process different aspects of the provided services. These modules may be provided by third parties. Thus, is would be a burden on the service provider to create and maintain a localization framework that can encompass the entire service including all add-on modules. For example, a business service may provide broad business computation services ranging from collection, analysis, and reporting to sales data to inventorying and/or timekeeping for employees, etc. Such a broad service may rely on third party providers' add-on modules for distinct aspects of the business service (e.g. one provider may deliver a timekeeping module, another may provide an inventory assessment module, etc.). It would not be reasonable to expect the service provider to localize all add-on modules with the same efficiency. On the other hand, individual third party providers (“partners”) may easily design localization resources for their respective add-ons.

In the example system of diagram 100, trusted server 102 represents such a third party provider that may provide localization resources to the service executed on scalable server 104. The localization resources may be stored and maintained at a localization repository 110. As discussed in more detail below, a portion of the entire localization repository 110 may also be maintained client-side, such that user 108 can access the service with localized rendering on their local client application (e.g. browser).

The resources or the content in the localization repository 110 may be protected from tampering through various trusted computing techniques such as a public-private key infrastructure, where missing or invalid signing of resources is rejected. This way, partners may be in control of their own private key for the repository content they provide, and must be authorized by the service provider to provide content to the repository. Other forms of trusted computing such as encryption, secure input/output (I/O), sealed storage, or remote attestation may also be employed.

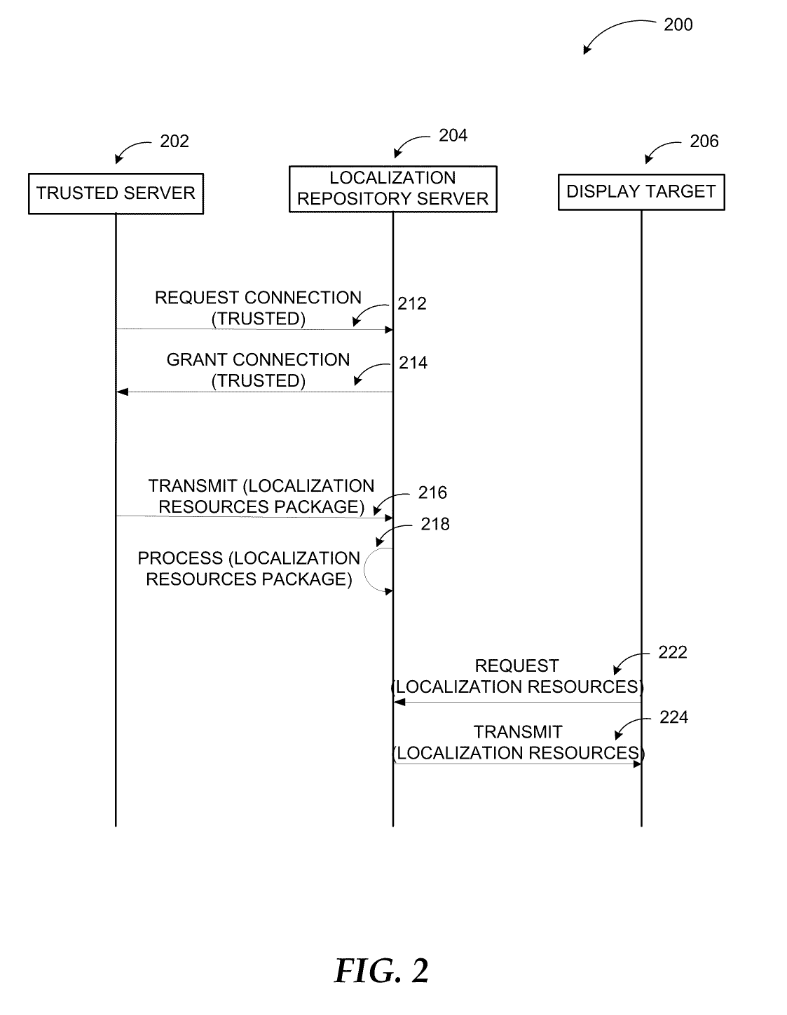

FIG. 2 includes action diagram 200 displaying management of localization resources. A system according to embodiments may include trusted server 202 representing a third party provider that may provide content for user interface localization repository. In an example operation, trusted server 202 may first request connection from localization repository server 204 (212). Upon granting of the trusted connection (214) such as a public-private key encrypted connection, trusted server 202 may transmit a localization resources package 216. A localization package may meet a client's specific application requirements and hold various resources such as audio files, video files, strings, drawings, images, and other resources to convert display target 206 from one localization to another. As discussed previously, this may include language localization or other forms of cultural and/or regional transformations.

Localization repository server 204 may process the received package (218) and update the user interface localization repository. Subsequently, a local user interface localization repository maintained at the display target 206 may be updated based on a request from display target 206 (212) or server initiated transmission of the update (224). The server may update the local user interface localization repository following changes to the server-side repository or periodically.

A display target is a group of characteristics of the user experience comprising a distinct combination of operating system(s), hardware and software environment, and technologies of computer-human interaction. Examples of these characteristics may include various desktop/mobile operating systems or runtime environments; distinct rendering and display methods such as an operating system graphical user interface (GUI), web page interface; different physical display sizes such as a laptop display, a netbook display, an interactive whiteboard, a pager display, a mobile phone display, an eBook reader display, and comparable ones. The characteristics may further include user input methods like keyboard, mouse, scanner, voice, multi-touch, gesture, and pen input; as well as network environments such as “always connected” (e.g. local or wide area networks, broadband, low bandwidth), “sometimes connected” (e.g. erratic connectivity, automotive computing, travel), or “offline with rare connectivity”.

The selection of the characteristics into a display target may depend on the use case, usability requirements, availability of hardware and system environment, network coverage, and/or physical workplace environment. The characteristics may require dedicated attention by the code that implements the display target. Some of those assets may have an orthogonal behavior and may not be used at the same time in the same place.

A user interface localization repository according to some embodiments may be a group of structured user interface content compiled into an assembly as binary resources accessible from running applications. The localized user interface content may include strings, images, icons, audio, and various files, and hold the localized version for a specific language or dialect.

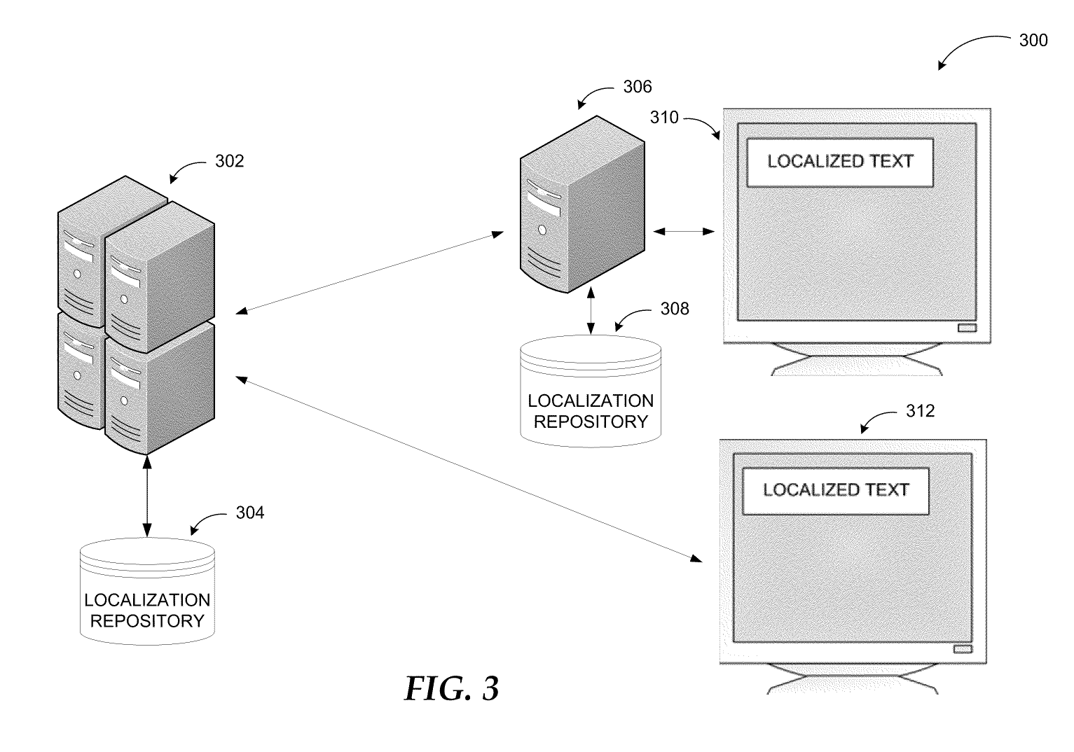

FIG. 3 includes conceptual diagram 300 illustrating hosted and on-premise localization resource services. User interface localization repository 304 may include all localization resources for the service(s) provided by servers 302. Following the previous example of a business service with various applications associated with distinct business aspects such as analysis, inventory monitoring, timekeeping, etc., each aspect of such a service may include different user interface localization resource since each module may require a different user interface.

According to some embodiments, a local user interface localization repository 308 may be maintained client-side (i.e. at server 306) in connection with the main user interface localization repository 304. The local repository may store a portion or all of the localization resources and be updated on-demand, periodically, or upon service provider initiation. The localization resources maintained at the local repository may be used to provide localized user interface at client device 310 such as localized text, graphics, audio, etc.

According to other embodiments, the user interface localization repository 304 may be a hosted repository and accessed by local client device 312 on demand. This implementation may be suitable in environments, where the client devices have continuous access to the service provider (“always connected” network environment) or clients are thin clients with limited local storage and/or processing capacity.

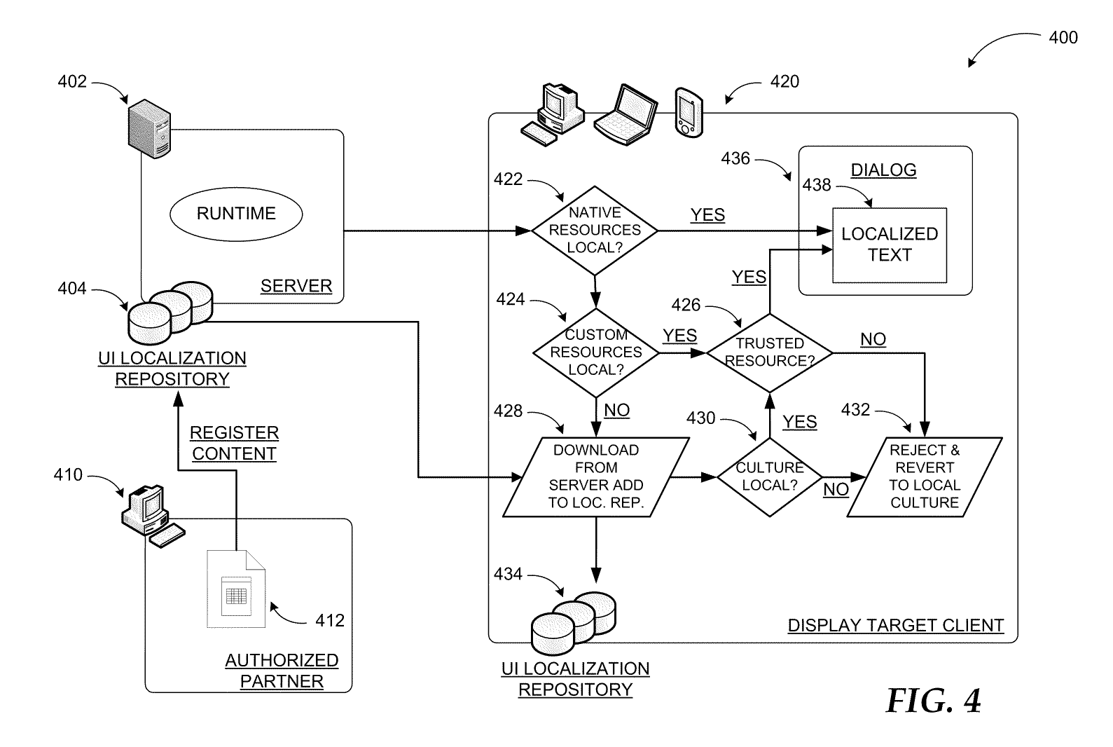

Diagram 400 of FIG. 4 illustrates another example localization system with an example process of maintaining up-to-date localization repository client-side. As discussed previously, a system according to embodiments provides a localization framework including a scalable server and a client side repository for shared user interface localization to be implemented in display target environments.

An example environment for embodiments is in context of business client-server applications, where the client on different display targets is dynamically created from a server side metadata model. The user interface localization repository 404 may include compiled assemblies optimized for load time and integrate them with models for localization within an existing framework. The complete (master) user interface localization repository 404 may be maintained at the scalable server 402 as a source for full or partial distribution (scheduled or at runtime). The same repository may be used for multiple display targets. The display target client 420 may have a full or a subset of the localization resources from the complete user interface localization repository 404 at the local user interface localization repository 434.

According to some embodiments, some or all of the content (412) in the user interface localization repository 404 may be received from third parties such as authorized partner 410. The resources or the content in the user interface localization repository 404 may be protected from tampering. Partners may register content to be provided through an authorization (and/or authentication) process.

According to other embodiments, a process of utilizing localization resources from server 402 at the display target client 420 may begin with determining whether native resources exist locally (422). If the native resources do exist locally, they may be used to localize user interface elements such as localized text 438 within dialog 436. If the native resources do not exist locally, another determination may be made as to whether custom resources exist locally (424). If custom resources exist locally, they may be checked to determine whether they are trusted resources (426). If they are, they may be used to localize the client user interface. If the local custom resources are not trusted, however, they may be rejected and the user interface reverted to a default culture (432).

If the custom resources are not available locally at the display target client 420, they may be downloaded from the user interface localization repository 404 at the server 402 and a determination made whether the culture exists locally (430). If the culture does not exist locally, the downloaded resources may be rejected and the user interface reverted to a default culture (432). If the culture does exist locally, however, the downloaded localization resources may be checked to determine whether they are trusted and then used for localizing the user interface at the client.

The example systems in FIG. 1 through 3 have been described with specific servers, clients, software, components, and interactions. Embodiments are not limited to systems according to these example configurations. Managing trusted localization resources in client-server systems may be implemented in configurations employing fewer or additional components and performing other tasks. Furthermore, specific protocols and/or interfaces may be implemented in a similar manner using the principles described herein.

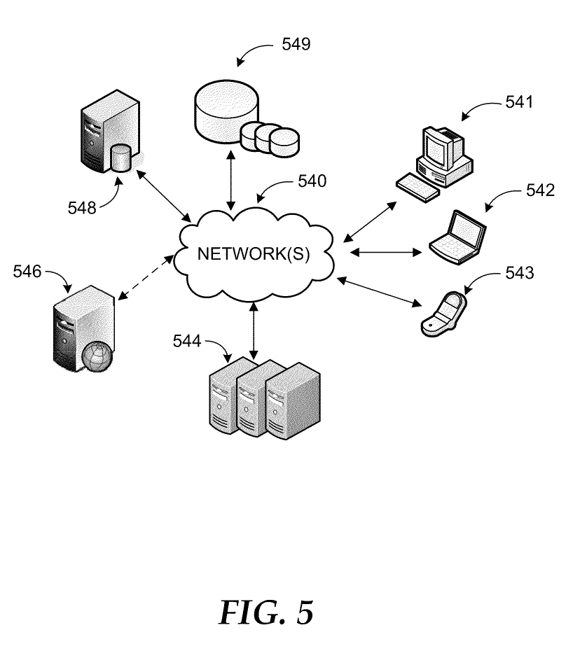

FIG. 5 is an example networked environment, where embodiments may be implemented. A platform managing trusted localization resources in client-server systems may be implemented via software executed over one or more servers 544 or a single server (e.g. web server) 546 such as a hosted service. The platform may communicate with thin client applications on individual computing devices such as a smart phone 543, a laptop computer 542, or desktop computer 541 (client devices') through network(s) 540.

As discussed above, localization repository server may host localization resources received from a trusted third party server. A user may request access to localized user interface at a client (e.g. a regular phone, a smart phone, a computer, a smart automobile console, etc.) and receive the localized user interface based on localization resources maintained at a local repository, which is updated from a server-side user interface localization resources repository.

Client devices 541-543 may compile localization resources received from a server (e.g. one of the servers 544 or individual server 546) as discussed previously. The remote application servers may retrieve or store relevant data from/to data store(s) 549 directly or through database server 548.

Network(s) 540 may comprise any topology of servers, clients, Internet service providers, and communication media. A system according to embodiments may have a static or dynamic topology. Network(s) 540 may include secure networks such as an enterprise network, an unsecure network such as a wireless open network, or the Internet. Network(s) 540 may also coordinate communication over other networks such as Public Switched Telephone Network (PSTN) or cellular networks. Furthermore, network(s) 540 may include short range wireless networks such as Bluetooth or similar ones. Network(s) 540 provide communication between the nodes described herein. By way of example, and not limitation, network(s) 540 may include wireless media such as acoustic, RF, infrared and other wireless media.

Many other configurations of computing devices, applications, data sources, and data distribution systems may be employed to implement a multi-tiered architecture with secure implementation of user interface localization resources. Furthermore, the networked environments discussed in FIG. 5 are for illustration purposes only. Embodiments are not limited to the example applications, modules, or processes.

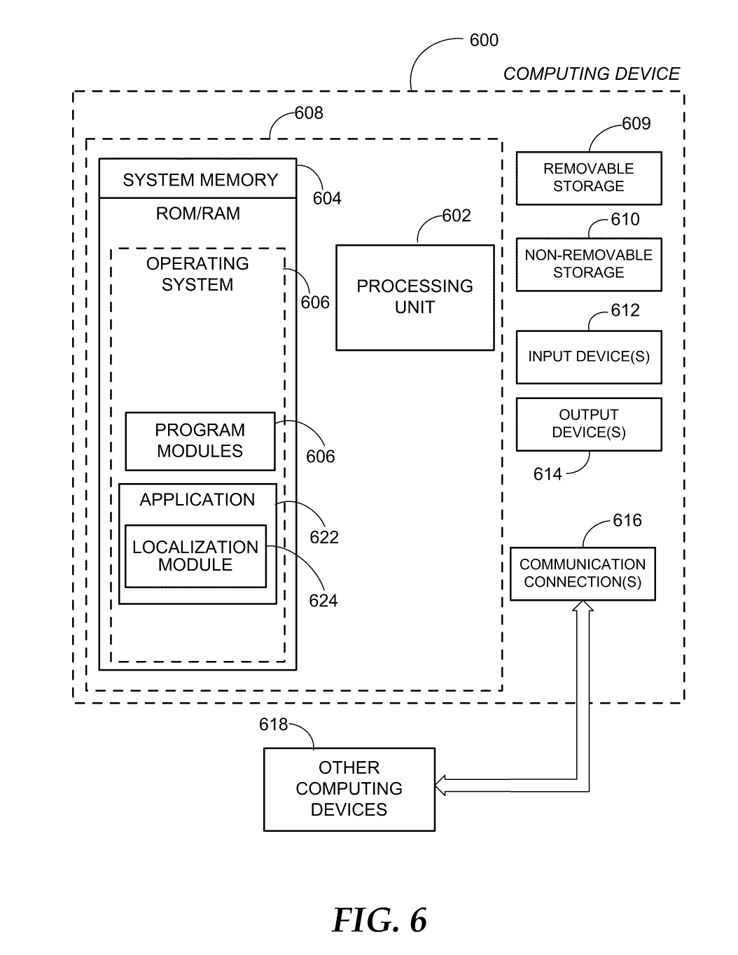

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a server executing a hosted service with user interface localization resources and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS® operating systems from MICROSOFT CORPORATION of Redmond, Wash. The system memory 604 may also include one or more software applications such as program modules 606, application 622, and localization module 624.

Application 622 may be any service provided to clients via on premise, hosted, or subscription based in the cloud modes. Localization module 624 may receive user interface localization resources from authorized third parties, maintain a user interface localization repository server-side, and update a client-side user interface localization repository storing a portion or all of the resources at the server-side repository as discussed previously. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute other applications, server, client devices, and comparable ones. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

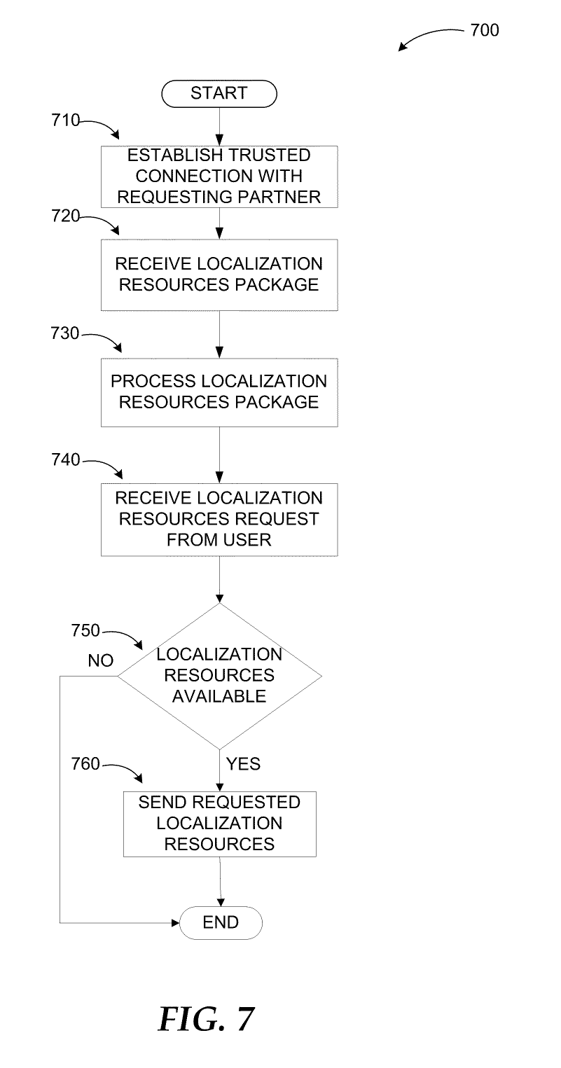

FIG. 7 illustrates a logic flow diagram for process 700 of managing localization resources in a server-client environment according to embodiments. Process 700 may be implemented by a server providing a service while maintaining a user interface localization resources repository.

Process 700 begins with operation 710, where the localization repository server may establish a trusted connection with an authorized partner. The authorized partner may be a localization update service of a third party vendor. At operation 720, the localization repository server may receive a localization resources package from the authorized partner for a portion of the user interface localization resources utilized by the service. At operation 730, the repository server may process the user interface localization resources package adding them to the complete user interface localization resources repository maintained at the server for all display target clients.

Upon receiving a request from a display target client at operation 740, the localization repository server may determine whether the requested user interface localization resources are available at the server-side repository at decision operation 750. If the resources are available at the server-side repository, the server may send them to the local user interface localization repository maintained at the display target client at operation 760 for use with the display target client user interface(s). Alternatively, the server may send regular or random updates to the local user interface localization repository maintained at the display target client as the main repository is updated.

The operations included in process 700 are for illustration purposes. Secure application of custom resources in multi-tier systems according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for secure application of user interface (UI) localization resources in multi-tier systems, the method comprising:
maintaining a server-side UI localization repository of localization resources for a plurality of display target clients;
enabling storage of at least a portion of the localization resources from the server-side UI localization repository at a client-side UI localization repository; and
maintaining synchronization between the server-side and the client-side UI localization repositories by one of: periodic update, on-demand update, and update upon change to the server-side UI localization repository.

2. The method of claim 1, further comprising:
compiling the localization resources at the server-side UI localization repository as assemblies optimized for load time.

3. The method of claim 2, further comprising:
integrating the compiled localization resources with models for localization within an existing framework.

4. The method of claim 1, further comprising:
receiving a portion of the localization resources at the server-side UI localization repository from an authorized third party provider.

5. The method of claim 4, further comprising:
employing one of an authorization, an authentication, and an encryption mechanism for enabling the third party provider to provide the portion of the localization resources to the server-side UI localization repository.

6. The method of claim 1, wherein the localization resources are associated with user interface customization based on at least one from a set of: a language, a dialect, a numbering system, a date/time system, and a cultural aspect.

7. The method of claim 1, wherein the localization resources include at least one from a set of: strings, images, graphics, files, audio data, and video data.

8. The method of claim 1, further comprising:
enabling a user interface at a client application to be customized, wherein customized elements of the user interface include at least one from a set of: text, graphics, and audio.

9. The method of claim 1, wherein the client-side UI localization repository is physically maintained at a client device.

10. The method of claim 1, wherein the client-side UI localization repository is hosted server-side and rendered accessible to a client application.

11. The method of claim 10, wherein the server-side hosted UI localization repository is provided to one of: thin clients and clients with an “always connected” network connection.

12. A server for providing secure application of user interface (UI) localization resources in multi-tier systems, the server comprising:
a data store; and
a processor coupled to the data store, the processor executing a service and a localization application, the localization application configured to:
generate a portion of localization resources for customizing user interfaces of a plurality of display target clients;
receive another portion of the localization resources from an authorized third party provider;
maintaining the localization resources in a server-side UI localization repository at the data store; and
maintaining a client-side UI localization repository based on at least a portion of the localization resources of the server-side UI localization repository.

13. The server of claim 12, wherein the localization resources are based on at least one from a set of: an operating system, a runtime environment, a rendering method, a display method, a user input method, and a network environment associated with a client.

14. The server of claim 12, wherein the user input method includes one of: a keyboard input, a mouse-based input, a gesture-based input, a pen-based input, and a voice-based input.

15. The server of claim 12, wherein the rendering method includes one of: an operating system graphical user interface and an application user interface, and wherein the display method includes a physical display size.

16. The server of claim 12, wherein the client-side UI localization repository is updated by the server based on a network environment.

17. The server of claim 12, wherein the server is a scalable server.

18. A computer-readable storage medium with instructions stored thereon for providing secure application of user interface (UI) localization resources in multi-tier systems, the instructions comprising:
generating a portion of localization resources for customizing user interfaces of a plurality of display target clients;
receiving another portion of the localization resources from an authorized third party provider;
maintaining the localization resources at a server-side UI localization repository;
maintaining a client-side UI localization repository based on at least a portion of the localization resources of the server-side UI localization repository; and
updating the client-side UI localization repository by one of: periodic update, on-demand update, and update upon change to the server-side UI localization repository.

19. The computer-readable medium of claim 18, wherein the instructions further comprise:
enabling the client to verify whether custom resources available to the client are local; and
if the custom resources are not local, enabling the client to retrieve the localization resources from the server-side UI localization repository.

20. The computer-readable medium of claim 18, wherein the instructions further comprise:
enabling the client to verify whether localization resources received from the server-side UI localization resources are applicable to the client; and
if the custom localization resources received from the server-side UI localization resources are not applicable to the client, enabling the client to revert to a local user interface.
